(19) United States
(12) Patent Application Publication
(10) Pub. No.: US 2009/0047547 A1
(43) Pub. Date: Feb. 19, 2009

(54) Nanopatterning of disk media with flash sacrificial layer in block copolymer lithography

(75) Inventors: Sooyoul Hong, Santa Clara, CA (US); Carl(Xiao) Dong Che, Saratoga, CA (US); Hyung Lee, Cupertino, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/891,903

(22) Filed: Aug. 13, 2007

(51) Int. Cl. G11B 5/33; B05D 5/12

(52) U.S. Cl. 428/800; 427/131

(57) ABSTRACT

A method for fabricating a patterned disk of a hard disk drive. The method includes forming a layer of magnetic material over a substrate and then forming a sacrificial flash layer over the layer of magnetic material. A co-polymer material is formed over the sacrificial flash layer and then a plurality of magnetic dots separated by a non-magnetic material are formed in the magnetic layer. The flash layer is preferably a FePt material with a non-magnetic Ag or Cu based alloy. Such material not only provides good adhesion between the co-polymer and magnetic layers but also diffuses into the grains of the magnetic material. The diffusion of the non-magnetic flash layer between the grains of the magnetic material reduces magnetic cross-talk and improves the signal to noise ratio of the disk.

### BACKGROUND OF THE INVENTION

1. Field of the Invention

The subject matter disclosed generally relates to disk media of hard disk drives.

2. Background Information

Hard disk drives contain a plurality of heads that are magnetically coupled to rotating disks. The heads write and read information by magnetizing and sensing the magnetic fields of the disk surfaces.

There are generally two different types of magnetic heads, horizontal recording heads and perpendicular recording heads (“PMR heads”). Horizontal recording heads magnetize the disk in a direction that is essentially parallel with the outer surface of the disk. PMR heads magnetize the disk in a direction essentially perpendicular to the outer surface of the disk. PMR heads are preferred because perpendicular recording allows for higher bit densities and corresponding increases in the data capacity of the drive.

The areal density of perpendicular recording is limited by magnetic cross-talk between adjacent areas of the disks. One approach to limiting cross-talk is to create a disk composed of a plurality of magnetic dots that are separated by non-magnetic material. The non-magnetic material inhibits magnetic cross-talk between the magnetic dots. Such disks are commonly referred to as-bit patterned media.

Bit patterned media can be fabricated by using a block of co-polymer material located on the magnetic material. The co-polymer material acts as a mask in a photo-lithography process used to form the bit pattern.

A layer of adhesive is typically applied to the magnetic layer to increase the adhesion between the co-polymer and the magnetic material. The adhesion layer is typically an Au or Ru material. Au and Ru materials are rare materials that are expensive to use.

### BRIEF SUMMARY OF THE INVENTION

A method for fabricating a patterned disk for a hard disk drive. The method includes forming a layer of magnetic material over a substrate and then forming a sacrificial flash layer over the layer of magnetic material. A co-polymer material is formed over the sacrificial flash layer and then a plurality of magnetic dots separated by a non-magnetic material are formed in the magnetic material.

### BRIEF DESCRIPTION OF THE DRAWINGS

FIG. 1 is a top view of a hard disk drive;

FIG. 2 is an illustration showing the fabrication of a disk during an intermediate process step.

### DETAILED DESCRIPTION

Disclosed is a method for fabricating a patterned disk of a hard disk drive. The method includes forming a layer of magnetic material over a substrate and then forming a sacrificial flash layer over the layer of magnetic material. A co-polymer material is formed over the sacrificial flash layer and then a plurality of magnetic dots separated by a non-magnetic material are formed in the magnetic layer. The flash layer is preferably a FePt material with a non-magnetic Ag or Cu based alloy. Such material not only provides good adhesion between the co-polymer and magnetic layers but also diffuses into the grains of the magnetic material. The diffusion of the non-magnetic flash layer between the grains of the magnetic material reduces magnetic cross-talk and improves the signal to noise ratio of the disk.

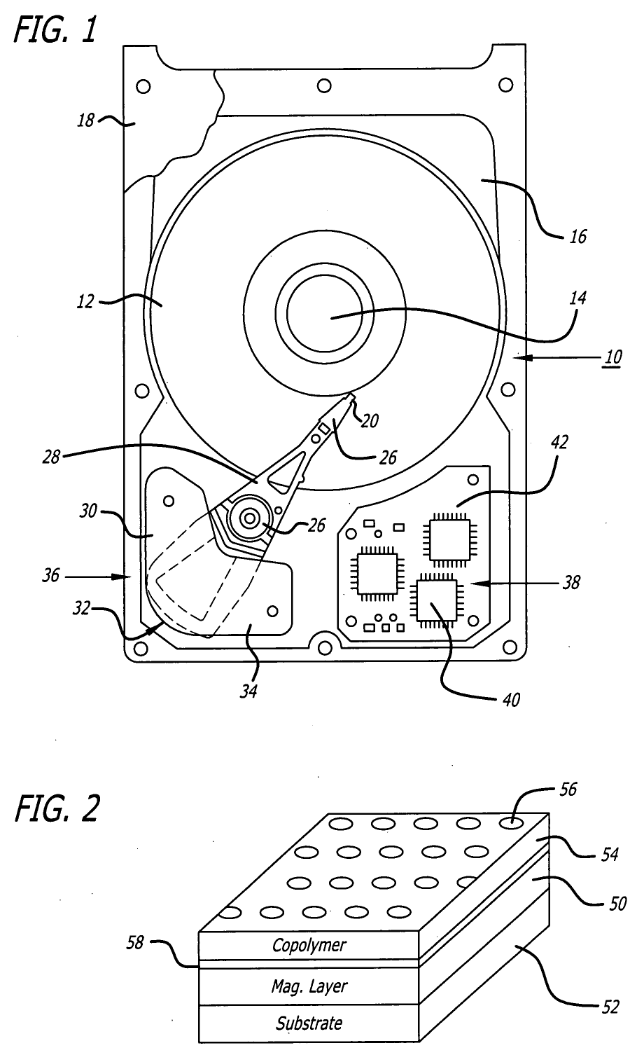

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

FIG. 2 shows a disk in an intermediate stage of fabrication. The disk includes a magnetic layer 50 formed over a substrate 52. A block of co-polymer 54 is located above the magnetic layer 50. The co-polymer 54 provides a masking function during a photolithographic process. The co-polymer 54 includes optical apertures 56 that allow light to travel therethrough and impinge on the magnetic material to induce a physiological change in the magnetic material. The apertures 56 may correspond to the formation of magnetic dots in the magnetic layer 50 to create a bit patterned media that has a plurality of magnetic dots separated by non-magnetic material.

A sacrificial flash layer 58 is located between the magnetic layer 50 and the co-polymer 54. The flash layer 58 may be a FePt material with a non-magnetic Ag based or Cu based alloy. The flash layer 58 improves the adhesion of the co-polymer 54 to the magnetic layer 50. The non-magnetic flash layer 58 also diffuses into the magnetic layer to create diffused non-magnetic material between the magnetic grains. The diffusion of non-magnetic material lowers magnetic cross-talk between the grains and improves the signal to noise ratio of the magnetic layer. The flash layer 58 also has relatively high mobility so that the co-polymer is more evenly applied to the magnetic material. The high mobility and surface energy characteristics of the flash layer also improves the surface smoothness of the disk.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for fabricating a patterned disk of a hard disk drive, comprising:
forming a layer of magnetic material over a substrate;
forming a sacrificial flash layer over the layer of magnetic material;
forming a co-polymer material over the sacrificial flash layer; and, creating a plurality of magnetic dots separated by a non-magnetic material.

2. The method of claim 1, further comprising removing the co-polymer material.

3. The method of claim 1, wherein the sacrificial flash material includes FePt and a non-magnetic Ag or Cu based alloy.

4. The method of claim 1, wherein the sacrificial flash material diffuses into the magnetic layer.

5. A bit patterned disk for a hard disk drive, comprising:
a substrate; and,
a magnetic layer that has a plurality of magnetic dots separated by non-magnetic material, said magnetic dots include magnetic grains separated by diffused non-magnetic material.

6. The disk of claim 5, wherein the diffused non-magnetic material includes a FePt material and a non-magnetic Ag or Cu based alloy.
